(19) United States
(12) Patent Application Publication
(10) Pub. No.: US 2026/0063784 A1
(43) Pub. Date: Mar. 5, 2026

(54) System and Method for Accurate Angle of Arrival Estimation of Targets using MIMO Radar

(71) Applicant: Renesas Design India Private Limited, Bengaluru (IN)

(72) Inventors: Sai Gunaranjan Pelluri, Bengaluru (IN); Apu Sivadas, Bengaluru (IN); Gireesh Rajendran, Bengaluru (IN)

(73) Assignee: Renesas Design India Private Limited, Bengaluru (IN)

(21) Appl. No.: 19/289,153

(22) Filed: Aug. 4, 2025

(30) Foreign Application Priority Data
Sep. 3, 2024 (IN) 202441066512

(51) Int. Cl. G01S 13/58; G01S 7/35; G01S 13/02

(52) U.S. Cl. CPC G01S 13/584; G01S 7/354; G01S 7/356; G01S 2013/0245

(57) ABSTRACT

According to an aspect, a system and method for providing an accurate Angle of Arrival (AOA) estimation of targets using a MIMO radar with FMCW modulation is disclosed. The system includes a doppler disambiguation, an updated range index module, a MIMO coefficient estimation module, a range bin migration phase correction, and an accurate angle of arrival estimation module. The doppler disambiguation is configured to estimate the true unambiguous doppler of detected targets. The updated range index module is configured to select the correct range bin across chirps for the detected targets, based on the true unambiguous doppler and the starting range bin. The MIMO coefficient estimation module is configured to calculate the amplitude and phase of the target signal across transmit and receive antenna combinations (MIMO coefficient estimates) based on the updated range index.

### CROSS REFERENCES TO RELATED APPLICATION

This application claims Priority from Indian Patent Application number 202441066512 filed on Sep. 3, 2024 which is incorporated herein in its entirety by reference

### BACKGROUND

### Field of Invention

Embodiments of the present disclosure relate generally to Frequency-Modulated Continuous Wave (FMCW) radar and more specifically to a system and method for providing an accurate Angle of Arrival (AOA) estimation of high-speed targets in multi-input-multi-output (MIMO) radar using FMCW modulation.

### Related Art

In a radar system sequence of chirps are transmitted as a radar signal. In that the chirps generally refers to frequency modulated signal where in the frequency varies linearly between two values. When an object (also referred to as target) moves at a high speed relative to the radar, the signal bin or a peak representing the object in the range spectrum shifts across chirps. The shifting of the peaks over the range bins is known as range bin migration in the FMCW-radar parlance.

As is well known, the velocity or doppler of the target is determined by processing the signal bins of the target across multiple chirps. The processing the signal bins across the chirps is also referred to as slicing of chirp samples. However, due to the range bin migration, slicing of chirp samples at a constant range bin may result in error. Further, the range bin migration introduces phase discontinuities across the chirps for the targets in the range spectrum. The range bin migration and the phase discontinuities results in loss of Signal-to-Noise Ratio (SNR) for Angle of Arrival (AOA) processing and may result in incorrect AOA measurements, which ultimately results in incorrect or noisy X, Y, and Z estimates of the high speed targets.

For example, referring to FIG. 1A, consider chirps 106A-106N forming an example radar signal with frequency linearly varying between F₁ and F₂ (the F₂−F₁ forming the chirp bandwidth). The bandwidth may be 2 GHz. Chirps 106A-106N are spaced in a particular time interval and the time interval is referred to as an inter-chirp time marked as 108. Now considering that each chirp is sent for the inter-chirp time of 44 μs (microseconds). For 140 chirps (N=140), a total time lapsed is 140*44 μs=6.16 ms. Now referring to FIG. 1B, shown there are the example range peak corresponding to a high speed target. As shown there, the first range R0 corresponds to range measured during a first set of chirps C1. Similarly the range R1 corresponds to the range measured during second set of chirps C2, and the range R2 corresponds to the range measure during third set of chirps C3. For example, during a first set of chirps C1, the range for a fast moving target is at a first range R0 and so on. That indicates that, the range of a high speed object has moved from one range bin to other over transmission of one frame. Now assume a target speed of 216 Km/hr (60 m/s). A time elapsed during transmission=140 Ramps*44 μs=6.16 ms and a distance moved while transmission=60*6.16-0.369 m. This shift will move the signal range bin by ˜5 range bins for radar configured with 2 GKz modulation bandwidth and a resultant range bin resolution of 0.075 m. The range resolution is defined as bin-to-bin interval. Consider an example where the first target is at 20th range bin i.e., R20 during the first ramp, then by the time the 140^{th} ramp approaches, the first target will shift to 25^{th} range bin i.e., R25, so using the same range bin for all the chirps for a high velocity target is not possible, Further, if the range of the target is continuously moving, then the power measured by selecting a constant range bin per target tends to drop as shown in FIG. 1C, resulting in degraded object detection performance of the radar system. This figure shows the energy graph with power drop 108 across chirps 106A-106N.

In case of the high-speed targets, the object range bin moves across the chirps, hence a method of using constant range bin across chirps for a given target (range bin slicing) will have significant amount of noise along with the signal from the true target. So, when a doppler Fast Fourier Transform (FFT) is performed for a constant range bin slice, the result is a degraded SNR and broadened main lobe width which results in lower gain. Further FIG. 1C shows the gain reduction of 20 dB for a fixed range bin for the high-speed target.

One of the prior arts (Range and Doppler Cell Migration in Wideband Automotive Radar by Zhihuo “Mars” Xu) discloses aRange and Doppler Cell Migration in Wideband Automotive Radar. The range and doppler value are estimated from 2-D FFT. After recording the range and doppler values, an IDFT is performed on slow time (across chirps), to create a new version of range FFT outputs and a Sinc interpolation is applied to fix the range (Rₒ) for each chirp and correct the phase from the doppler value estimated from 2-D FFT. This corrected signal will rectify the range migration and will have the signal energy at a constant range bin Rₒ and a constant doppler FFT bin corresponding to vᵢ even for high speed targets. The limitations of this method are the high computation required for sync interpolation for real time operation and the loss in SNR due to the range bin migration at the time of target detection.

Another prior art discloses a Keystone transformation for correcting the range bin migration in a range-doppler processing. The disclosure talks about a frequency dependent scaling in slow time which is followed by a re-sampling of a signal in the slow time. Once the coupling term is removed from the FFT in fast time, the system can go back to time domain samples and can estimate the target range and doppler. The disclosure discloses interpolation and re-sampling which requires a compute heavy process in real time operation. Further the disclosure does not address the bin migration problem in the single transmission and the MIMO-FMCW-radar.

Therefore, there exists a need for advancement in range bin migration correction techniques.

### SUMMARY

According to an aspect, a system for providing an accurate Angle-of-Arrival (AOA) estimation of targets using a MIMO radar with FMCW modulation is described. The system includes a Doppler disambiguation, an updated range index module, a MIMO coefficient estimates module, a range bin migration phase correction, and an accurate angle of arrival estimation module. The Doppler disambiguation is configured to estimate a true unambiguous doppler of detected targets. The updated range index module is configured to select the correct range bin across chirps for the detected targets, based on the true unambiguous doppler and the starting range bin (range bin of the target at the first chirp). The MIMO coefficient estimates module is configured to calculate the amplitude and phase of the target signal across transmit and receive antenna combinations (MIMO coefficient estimates) based on the updated range index. The range bin migration phase correction is configured to correct the phase error introduced by range bin migration in MIMO coefficient estimates. The accurate angle of arrival estimation module is configured to calculate an accurate AOA estimate using the corrected MIMO coefficients.

According to another aspect, a method for providing a system for an accurate Angle-of-Arrival (AOA) estimation of Targets using a MIMO radar with FMCW modulation. The method includes processing a known ambiguous doppler to obtain a true unambiguous doppler of targets. The method further includes obtaining an updated range index based on the true unambiguous doppler and starting range bin of the target. The method further includes configuring a MIMO coefficient estimates module, to estimate the MIMO coefficients based on the updated range index. The method further includes configuring, a range bin migration phase correction, to correct a range bin migration phase using the MIMO coefficient estimates. The method further includes configuring, an accurate angle of arrival estimation module, to calculate an accurate AOA estimate using the MIMO coefficients extracted post correction of target range bins.

Several aspects are described below, with reference to diagrams. It should be understood that numerous specific details, relationships, and methods are set forth to provide a full understanding of the present disclosure. One who skilled in the relevant art, however, will readily recognize that the present disclosure may be practiced without one or more of the specific details, or with other methods, etc. In other instances, well-known structures or operations are not shown in detail to avoid obscuring the features of the present disclosure.

### BRIEF DESCRIPTION OF DRAWINGS

FIG. 1A illustrates chirps forming an example radar signal

FIG. 1B illustrates example range peaks shifting of a high-speed targets over different chirps.

FIG. 1C illustrates power measured by selecting a constant range bin.

FIG. 2A illustrates a block diagram of an example Frequency Modulated Continuous Wave (FMCW) radar system according to some embodiments herein.

FIG. 2B illustrates the three dimensional data from a plurality of the receiver antennas.

FIG. 3 is a block diagram illustrating the manner in which the AOA estimator may provide more accurate AOA estimation.

FIG. 4A and FIG. 4B respectively illustrates an accurate AOA estimator in an embodiment and slicing of the chirps with updated range.

FIG. 5 is a graph illustrating a power variation across MIMO channel with and without range bin migration correction, according to some embodiments herein.

FIGS. 6A through 6C illustrates the phase compensation for the range bin migration according to some embodiments herein.

FIGS. 7A and 7B are graphs illustrating the uniform linear array (ULA) phase without range bin update, with range bin update and with phase correction.

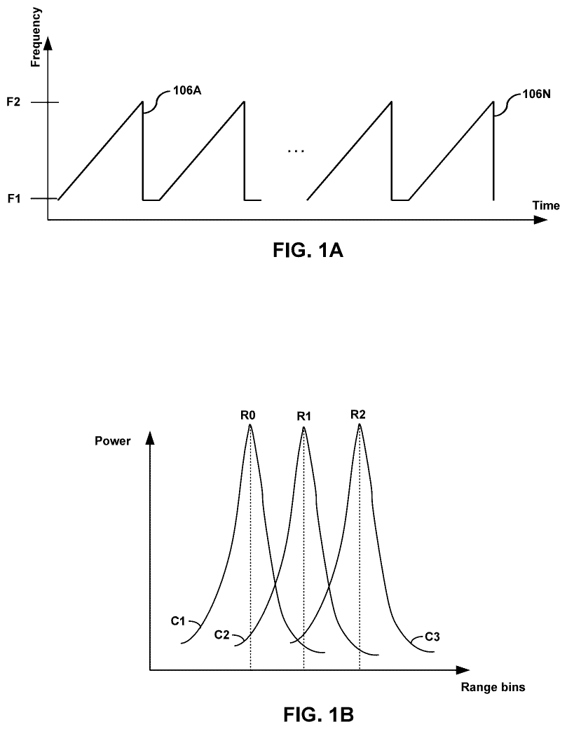

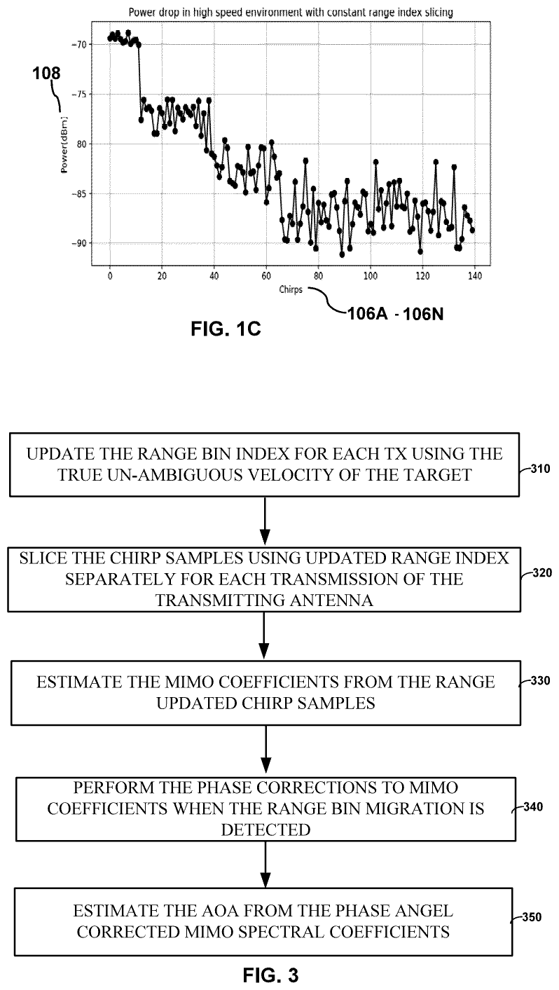

### DETAILED DESCRIPTION OF THE PREFERRED EXAMPLES

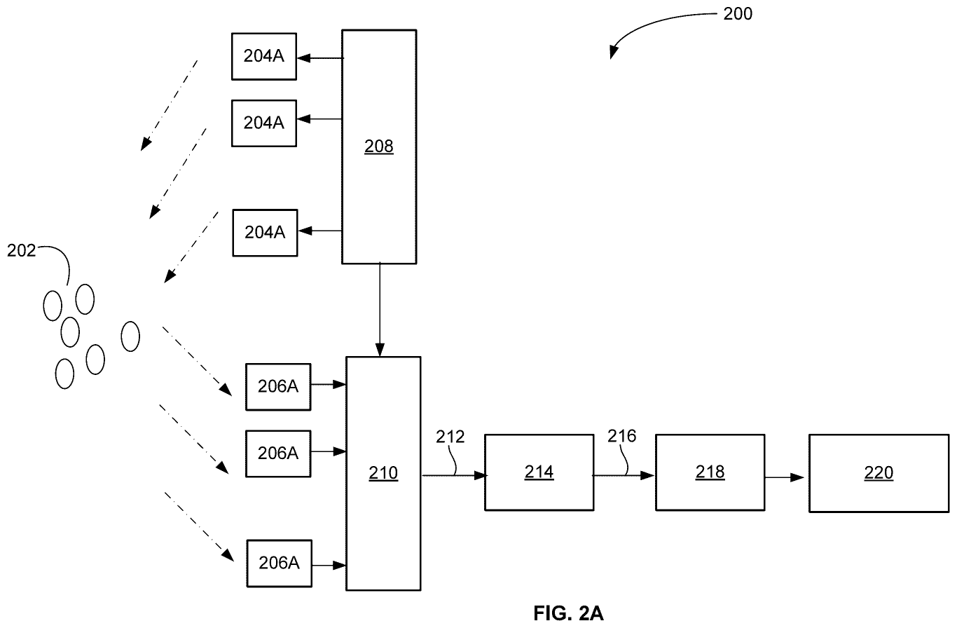

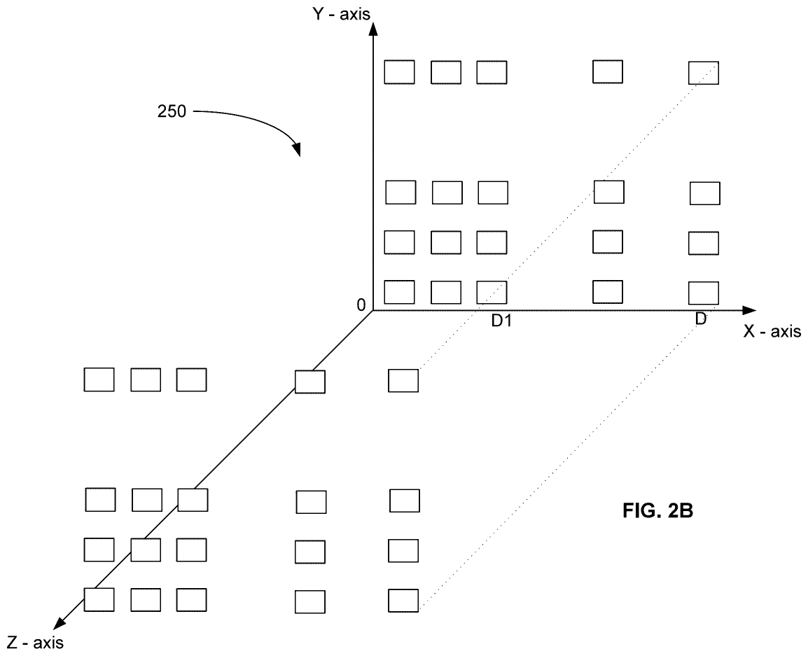

FIG. 2A illustrates a block diagram of an example Frequency Modulated Continuous Wave (FMCW) radar system 200, according to some embodiments herein. The system 200 includes high speed target or object 202, one or more transmitting antenna array 204A-204N, receiving antenna array 206A-206N, a transmitter block 208, a mixer 210, a filter 214, an Analog to digital convertor (ADC) 218 and a AOA estimator 220. Each element is described in further detail below.

The transmitting antenna array 204A-204N and the transmitter 208 operate in conjunction to transmit frequency signal over a desired direction. The transmitter 208 generates a radar signal for transmission and provides the same to the transmitting antenna array 204A-204N for transmission. The transmitting antenna array 204A-204N is employed to form a transmit beam with an antenna aperture to illuminate objects at suitable distance and of suitable size. Various known beam forming techniques may be employed for changing the illuminated region. The transmitter 208 may generate a sequence of chirps (a set of chips forming a frame) as the radar signal. The transmitter 208 may selectively transmit the number of chirps over multiple transmit antennas either in sequence or in parallel. For example, a first subset of chirps from the frame may be configured to transmit on first antenna and a second subset of chirps from the frame may be configured to second transmit antenna soon and so forth.

The receiving antenna array 206A-206N includes antenna elements each element capable of receiving the reflected signal. The receiving antenna array 206A-206N is employed to form an aperture to detect objects with a desired resolution (for example, two objects separated by a suitable distance). The signal received on each of the elements, corresponding to the transmitted chirps is provided to the mixer 210.

The mixer 210 mixes frequency signal received on each antenna element in the array with the transmitted frequency signal (local oscillator frequency) to generate an intermediate frequency signal (IF signal). In that, the mixer 210 may include number of complex or real mixers to mix each chirp received on the corresponding antenna elements. Alternatively, the mixer 210 may include fewer mixers multiplexed to perform the desired operation. The intermediate frequency (IF) signal is provided on path 212 to filter 214. The filter 214 passes the IF signal attenuating the other frequency components (such as various harmonics) received from the mixer 210.

The filter 214 may be implemented as a pass band filter to pass a desired bandwidth (in conjunction with chirp bandwidth BW). The filtered IF signal is provided on path 216 to ADC 218. The ADC 218 converts IF signal received on path 216 (analog IF signal) to digital values. The ADC 218 may sample the analog IF signal at a sampling frequency Fs and convert each sample value to a bit sequence or binary value. The digitized samples of IF signal (digital IF signal) is provided for further processing to the AOA estimator 220.

FIG. 2B illustrates the three dimensional data 250 from a plurality of the receiver antennas (206A-206N). In that, X-axis representing the range bins, Y-axis representing the Chirps and Z-axis representing the transmitters (each antenna receiving the chirps in the receiver). The Y axis is shown to comprise 0-D1 chirps followed by D-D1 chirps. Accordingly, the range bins are sampled across the Y axis (across the chirps) to determine the Doppler. The sampling the range bins across the chirps is referred to as the slicing the chirp. Similarly, the X-Y coefficient across the Z-axis (that is across the receiver antennas) is generated to determine the angle of arrival. These coefficients are referred to as antenna coefficients or MIMO coefficients. The three dimensional data (ADC samples) are generated by ADC 218 sampling the received signal.

It may be appreciated that ADC samples/three dimensional data 250 corresponds to transmitter transmitting the chirps multiplexed in time domain. Accordingly, the three dimensional data 250 required to be compensated for range bin migration corresponding to each transmitter (antenna transmitting the signal). Thus, in one embodiment, the three dimensional data corresponding to the 0-D1 and D-D1 chirps are processed for reducing the error in AoA.

The AOA estimator 220 reduces the error due to range bin migration and phase discontinuities to provide an accurate AOA estimation of the high speed targets. FIG. 3 is a block diagram illustrating the manner in which the AOA estimator may provide more accurate AOA estimation. In block 310, the AOA estimator 220 updates the range bin index for each Tx using the true un-ambiguous velocity of the target. In one embodiment the first D1 chirps are used for determining the preliminary range-doppler values. The true un-ambiguous velocity of the target may be determined using technique disclosed in one of the earlier patent application of the instant applicant. The Range bin index is updated from the known un-ambiguous velocity and a preliminary range determined from a first set of chirps (0-D1).

In block 320, the AOA estimator 220 slices the chirp samples using updated range index separately for each transmission of the transmitting antenna. In an embodiment, the remaining chirps sample D-D1 may be sliced using updated range index. In block 330, the AOA estimator 220 estimates the MIMO coefficients from the range updated chirp samples. In block 340, the AOA estimator 220 performs the phase corrections to MIMO coefficients when the range bin migration is detected. In one embodiment, a phase correction of

$$π - \frac{π}{N}$$

radians is applied to the MIMO coefficients that corresponds to set of chirps transmitted by a transmitter for which a bin migration is detected. In that, N representing the number of samples in one chirp. In block 350, the AOA estimator 220 estimates the AoA from the phase angel corrected MIMO spectral coefficients received from block 340. The AoA may be determined using any known technique. The manner in which the AOA estimator 220 estimates the AoA with reduced error is further described in detail below.

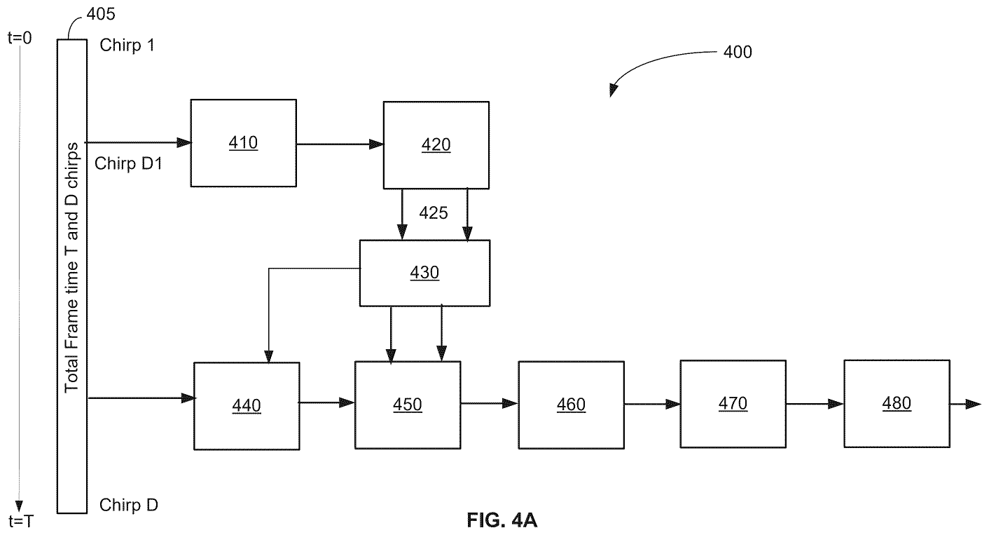

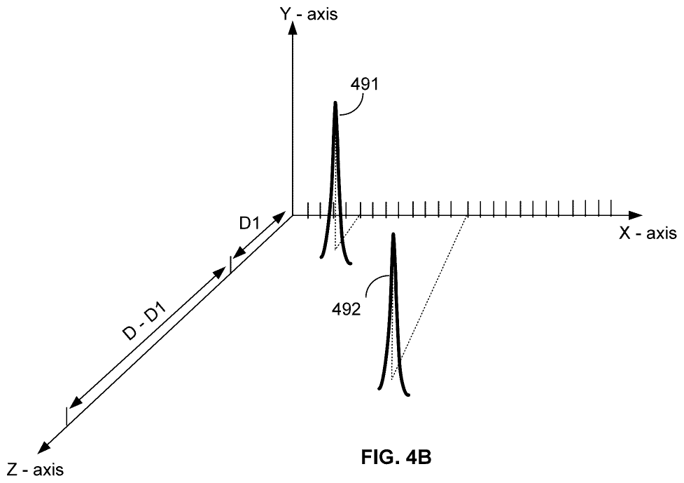

FIG. 4A illustrates an accurate AOA estimator 220 according to some embodiments herein. The AOA estimator 400 includes an (FFT based) range-doppler processor 410, a detection of valid (or desired) range-doppler values module 420, a doppler disambiguation module 430, a FFT based range processor 440, a chirp slicing module 450, a spectral coefficient estimation (in doppler domain) module 460, a range bin migration phase correction module 470, and a AOA processor 480.

The FFT based range-doppler processor 410 is configured to perform a first range processing and a doppler processing on a first set of chirps to obtain a range and doppler value from the first set of chirps. The first set of chirps may be selected from the total number of chirps in a frame. In certain embodiment, the first set of chirp may comprise the set of chirps transmitted by one of the transmitter. For example, as shown in 405, when the number chirps in a frame spanning time interval T=0 to T=Tx is D. A first set of chirps D1 (224) derived from the D chirps are provided to the module 410. The D1 chirps may be transmitted from one of the transmitter among the plurality of the transmitters. The D1 chirps may also be first set of chirps received in the frame.

The module 420 is configured to detect/select valid or desired Range (R)-Doppler (D) values from the range and doppler values derived from the module 410. For example, a threshold may be set to select peaks to eliminate spurious reflection or reflection from non candidate objects. The detected valid or desired range-doppler values 425 are processed by the doppler disambiguation module 430 to obtain the true velocity of the high-speed target. The disambiguation module 430 may provide the un-ambiguous doppler velocity noted in the above sections.

The FFT based range processor 440 is configured to perform a second range processing on remaining chirps in the frame (for example, D-D1 chirps in the frame). The D-D1 chirps are provided to the module 440 to determine the range information. Each chirp includes N samples of data of the high-speed target. An updated range of the high-speed target is determined based on the true velocity, detected ranges from D1 chirps and the samples received corresponding to D-D1 chirps using the relation/equation: R_{updated}=R+v*Δt, in that, the R representing the ranges determined from the D-D1 chirps and v representing the doppler determined from D1 chirps in the 410 module and the Δt representing the time between two successive transmission (for example Δt=number of chirp in one transmission*inter chirp time interval).

The chirp slicing module 450 slices the chirps based on the updated range of the high-speed target. In one embodiment, the sampling instances are shifted by the corresponding shift in the range index determined from the updated range in block 430. FIG. 4B illustrates the slicing of the chirps with updated range. In that, X-axis representing the range bins, Z axis represent the chirps (frame) and Y axis representing the power. As shown there, the range peak 491 represents the range determined from the signal transmitted by first transmitter (first set of chirps D1). The peak 492 representing the updated range determined corresponding to the signal transmitted from second/subsequent transmitter (chirp D-D1). As shown the updated range is shown to have moved/shifted by 8 range bins due to high speed. In one embodiment, the sampling instant across the chirp is shifted by a value equal to the shift in the range bins. As a result, the sample of ranges across the chirps corresponds to the range peak of the same object moving at high speed.

The spectral coefficient estimation in Doppler domain module 460 calculates spectral coefficient using MIMO coefficients received from the block 450 (samples drawn from all the receiving antennas across the chirps). The block 460 may perform known operation such as FFT operation to convert the samples to spectral coefficients. The spectral coefficients are provided to the block 470. The spectral confidents are complex values with amplitude and phase value. The range bin migration phase correction module 470 performs the phase correction to the received spectral coefficient by correcting the phase component of the complex values. In one embodiment the phase corrections are applied to the coefficients that correspond to the chirps transmitted by a transmitter for which range migrations are detected. The phase angle is corrected by a factor π-π/N as noted above. In certain embodiment, when N is large the correction factor may be equal π. The corrected coefficients are is used for processing the accurate AOA of the high-speed targets.

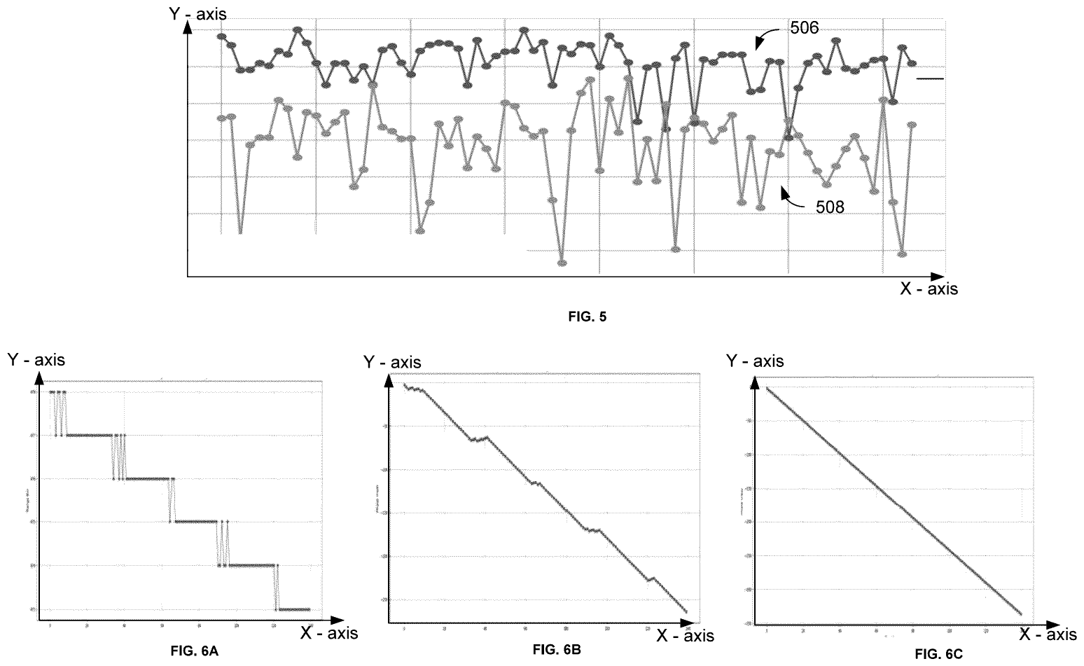

FIG. 5 is a graphs illustrating a power variation across MIMO channel with 506 and without 508 range bin migration correction, according to some embodiments herein. The graph shows power across MIMO channel as a plot against power (dB) and uniform linear array indices for with range bin migration correction 506 and without range bin migration correction 508. In FIG. 5, the x-axis is the MIMO channels arranged in an uniform linear array and the Y axis is the power in db. The signal power variation across MIMO channels is about 10 dB when the range bin update is applied, while it is −15 to −20 dB without the range bin update. Therefore, the range bin update necessarily slice the true signal which boost the AoA SNR, this directly enhances the angle estimate accuracy of the target.

FIGS. 6A-6C illustrates the effect of phase compensation for the range bin migration according to some embodiments herein. In the Figures, X-axis representing chirp numbers and Y-axis representing the range bins. the Referring to FIG. 6A shows a target range bin movement across chirps. Referring to FIG. 6B shows a doppler phase for high speed target aliased to lower speed. Referring to FIG. 6C shows the doppler phase for high speed target aliased to lower speed post phase compensation after applying the correction of

$$( π - \frac{π}{N} )$$

radians for the phase correction.

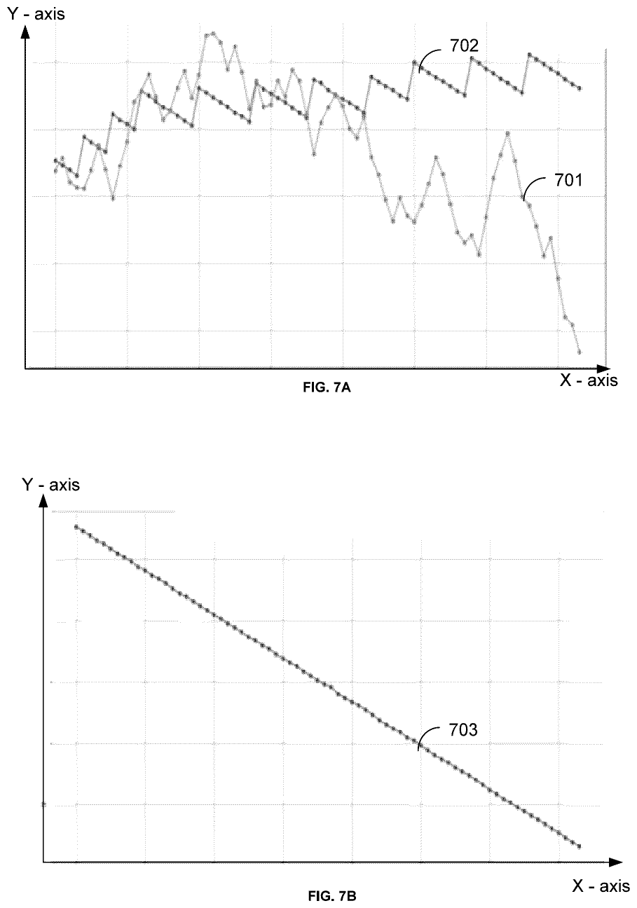

FIGS. 7A and 7B are graphs illustrating the uniform linear array (ULA) phase without range bin update, with range bin update and with phase correction. In the Figures, the X-axis representing the azimuth ULA index and Y axis representing the phase in radians. The graph 701 in FIG. 7A depicts the ULA phase discontinuities/jumps in the absence of range update and phase correction. The graph 702 depicts the partially restored linear phase structure with some phase jumps due to doppler dependent range updated in which the true range bins are sampled. The graph 703 in the FIG. 7B illustrates the ULA phase after the phase correction at the point of bin migrations.

While various examples of the present disclosure have been described above, it should be understood that they have been presented by way of example, and not a limitation. Thus, the breadth and scope of the present disclosure should not be limited by any of the above described examples, but should be defined in accordance with the following claims and their equivalents.

What is claimed is:

1. A system (300) for providing an accurate Angle of Arrival (AOA) estimation of targets using a Multiple In Multiple Out (MIMO) radar with a Frequency Modulated Continuous Wave (FMCW) modulation, the system comprising:
a doppler disambiguation that is configured to estimate a true unambiguous doppler of detected targets;
an updated range index module that is configured to select a correct range bin across chirps for the detected targets, based on the true unambiguous doppler and a starting range bin,
a MIMO coefficient estimates module that is configured to calculate an amplitude and a phase of a target signal across transmit and receive antenna combinations based on the updated range index;
a range bin migration phase correction that is configured to correct a phase error introduced by a range bin migration in the MIMO coefficient estimates; and
an accurate angle of arrival estimation module that is configured to calculate the accurate AOA estimates using the corrected MIMO coefficients.

2. The system as claimed in claim 1, wherein the phase correction of
$$π - \frac{π}{N}$$
radians is applied to every range bin migration interval.

3. The system as claimed in claim 1, wherein the updated range index is R_{updated}=R+v*Δt, where v is a known velocity of the target and Δt is a time elapsed between successive Tx transmissions.

4. A method for providing a system for an accurate Angle of Arrival (AOA) estimation of targets using Multiple In Multiple Out (MIMO) radar with a Frequency Modulated Continuous Wave (FMCW) modulation, the method comprising:
Determining a first plurality of range bins and corresponding a plurality of unambiguous doppler of plurality of targets from a first set of chirps;
Updating range indexes of the plurality of the range bins based on the unambiguous doppler and first plurality of the range bins;
Generating a plurality of MIMO coefficient estimates from the updated range indexes;
Correcting phase components of the MIMO coefficient estimates when the range bin index is updated; and
Determining angle of arrival estimation from the phase compensated using the MIMO coefficients.

5. The method as claimed in claim 4, wherein the phase correction of
$$π - \frac{π}{N}$$
radians is applied to every range bin migration interval.

6. The method as claimed in claim 4, wherein the updated range index is R_{updated}=R+v*Δt, where v is a known velocity of the target and Δt is a time elapsed between successive Tx transmissions.
